(19) United States
(12) Patent Application Publication
(10) Pub. No.: US 2007/0228807 A1
(43) Pub. Date: Oct. 4, 2007

(54) Customized hubcap attachment system

(76) Inventors: Jerry Leslie, Vancouver, WA (US); William Scott, Vancouver, WA (US)

Correspondence Address: RYLANDER & ASSOCIATES PC, 406 WEST 12TH STREET, VANCOUVER, WA, 98660, US

(21) Appl. No.: 11/395,741

(22) Filed: Mar. 30, 2006

(51) Int. Cl. B60B 7/04

(52) U.S. Cl. 301/37.26

(57) ABSTRACT

A customized hubcap attachment system to provide interchangeable hubcaps allowing use of different ornamental hubcaps for different occasions includes a wheel with an interior rim, a hubcap mount attachable to said wheel interior rim, and an interchangeable hubcap plate removably attachable to the hubcap mount. A customized hubcap attachment kit.

### FIELD OF THE INVENTION

This invention relates generally to the field of hubcap attachment systems.

### BACKGROUND

A hubcap covers at least the central portion of an automobile's wheel. Automobiles are sold with hubcaps which are typically standard for the make and model. The hubcaps serve to protect the wheel, metal rim of the wheel and lug nuts, as well as enhance the car's appearance. Hubcaps frequently bear designs and indicia for ornamental effect. An existing problem for automobile owners occurs when the automobile owner wishes to change hubcaps in order to have different designs on their wheels.

Previous options for interchanging hubcaps to tires required replacing the entire hubcap. Replacing the hubcap required extensive time input as well as the proper tools, typically a lug wrench or a screw driver. The automobile owner did not have the option of replacing a portion of the hubcap. The process of replacing the existing hubcap entailed removing the screws holding it in place, unsnapping the hubcap from the tire rim, or wrenching loose approximately six lug nuts holding it in place. No mechanism for replacing a portion of a hubcap existed. Another option was to take the car to a mechanic and pay someone to replace the hubcaps. However, this option was expensive, inconvenient, and even more time consuming.

### SUMMARY AND ADVANTAGES

A customized hubcap attachment system to provide interchangeable hubcaps to allow use of different ornamental hubcaps for different occasions includes a wheel with an interior rim, a hubcap mount attachable to said wheel interior rim, and an interchangeable hubcap plate removably attachable to the hubcap mount. The hubcap mount may include downward extending tabs with protruding lips which snap fit to said wheel rim. The interchangeable hubcap plate may include a protrusion on the interior wall of said hubcap plate and the hubcap mount may include a recess on an exterior side wall of said hubcap mount so that the protrusion can snap fit into the recess thereby fastening the plate to the mount. A customized hubcap attachment kit is also provided.

The customized hubcap attachment system of the present invention presents numerous advantages, including: (1) ease in interchangeability of ornamental hubcaps; (2) flexibility to have many different hubcaps with designs for different occasions; (3) ease in replacement of portions of hubcaps.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a detailed embodiment of the present invention.

FIG. 2 shows a top view detailed embodiment of FIG. 1.

FIG. 3 shows a side view detailed embodiment of FIG. 1.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

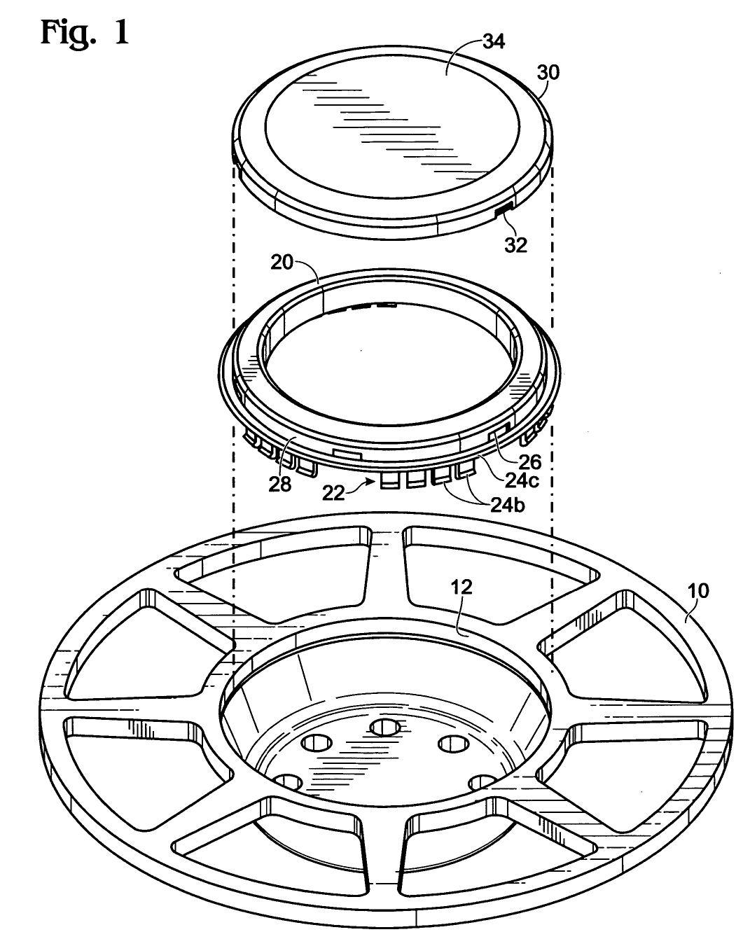

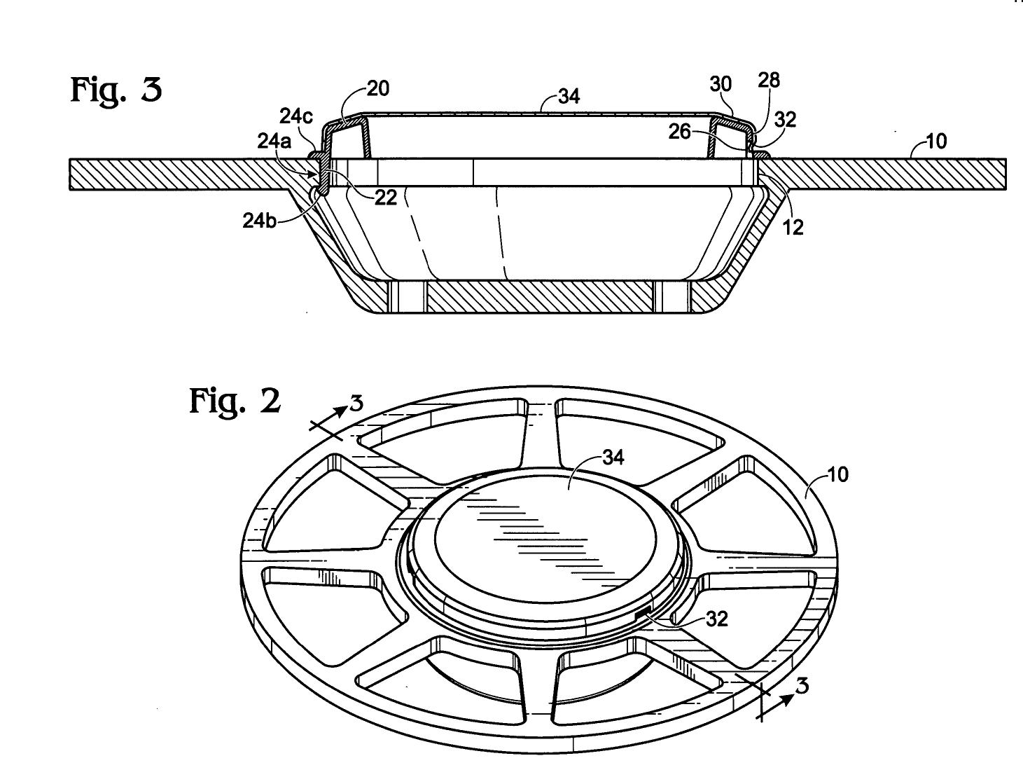

A customized hubcap attachment system is provided to allow easily interchangeable hubcaps for use of different ornamental hubcaps for different occasions. As shown in FIGS. 1-3, a customized hubcap attachment system includes a wheel 10 with an interior rim 12, a hubcap mount 20 attachable to said wheel interior rim, and an interchangeable hubcap plate 30 removably attachable to the hubcap mount 20. The hubcap mount 20 may include downward extending tabs. 22 with protruding lips 24 which snap fit to said wheel rim 12. The interchangeable hubcap plate 30 may include an inwardly directed protrusion 32 of said hubcap plate 30 and the hubcap mount 20 may include a recess 26 on an exterior side wall 28 of said hubcap mount 20 so that the protrusion 32 can snap fit into the recess 26 fastening the plate 30 to the mount 20. A customized hubcap attachment kit is also provided. The top face 34 of said hubcap plate 30 can contain any lettering, sign, symbol, or artwork the automobile owner chooses.

In the preferred embodiment, as depicted in FIGS. 1-3, said wheel 10, includes an interior rim 12. The mount 20 preferably includes downward extending tabs 22 with protruding lips 24 defining a cross channel 24a into which the wheel 10 interior rim 12 snaps as shown in FIG. 3, thereby securing the removable hubcap mount 20 to the wheel 10. In the preferred embodiment, mount 20 is provided with sixteen downward extending tabs 22 with protruding lips 24 to secure said mount 20 to said wheel 10 rim 12. Those of skill in the art will know that the mount 20 can be attached to the wheel using other mechanisms, including clamps, fasteners, clips, clasps, hooks, bolts, screws, pins, pegs, nails, dowels, grooves, channels, tracks, latches, locks, recesses, protrusions, rims, adhesives, or magnets.

In the preferred embodiment, the mount 20 includes a recess 26 on an exterior side wall 28 of said mount 20, as depicted in FIGS. 1 and 3. Those of skill in the art will know that the interchangeable plate 30 can be removably attached to the mount 20 using other mechanisms, including clamps, fasteners, clips, clasps, hooks, bolts, screws, pins, pegs, nails, dowels, grooves, channels, tracks, latches, locks, recesses, protrusions, rims, adhesives, or magnets.

The interchangeable hubcap plate 30 is preferably secured to the removable hubcap mount 20 by four interior wall protrusions 32 which snap fit into matching recesses 26 in the exterior side wall 28 of the mount. The protrusion 32 snaps into a recess 26 on the exterior side wall 28 of the mount 20, thereby securing the removable hubcap plate 30 to the removable hubcap mount 20, as shown in FIG. 3. Those of ordinary skill in the art will know that plate 30 can be secured to the mount 20 by other types of attaching mechanisms including clamps, fasteners, clips, clasps, hooks, bolts, screws, pins, pegs, nails, dowels, grooves, channels, tracks, latches, locks, recesses, protrusions, rims, adhesives, or magnets.

The top face 34 of the removable hubcap plate 30 can contain any lettering, sign, symbol, design, or artwork the automobile owner chooses. The owner may easily interchange one removable hubcap plate 30 for another by releasing the removable hubcap fastening mechanism 32 and fastening a new removable hubcap plate 30 to the removable hubcap mount 20.

In use, owner may have different hubcap plates 30 with different designs to suit special occasions and with the invention easily swap the designs between wheels and between cars. The car is outfitted with wheels 10. Removable hubcap mounts 20 are attached to the wheels 10, preferably by snap fitting downward extending tabs 22. Designed plates 30 may be removably attached as the occasion determines. For instance, an owner can have hubcap plates with Marine Corps insignia, and also have hubcap plates with professional football team insignia. Owner can attach hubcap plates with Marine Corps insignia to hubcap mounts easily by snapping the plates to the mounts 20. On football game day, owner can snap off the Marine Corps insignia plates and snap on the professional football team insignia plates. The insignia on the plates 30 is left to the owner's discretion.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A customized hubcap attachment system, comprising:
a wheel with an interior rim;
a hubcap mount attachable to said wheel interior rim; and
a hubcap plate having a top face removably attachable to the hubcap mount.

2. The system of claim 1, wherein said hubcap mount includes a downward extending tab with protruding lips which snap fit to said wheel rim.

3. The system of claim 1, wherein said plate includes a protrusion, and wherein said mount comprises a recess, whereby said protrusion snap fits into said recess fastening said plate to said mount.

4. The system of claim 2, wherein said plate includes a protrusion, and wherein said mount comprises a recess, whereby said protrusion snap fits into said recess fastening said plate to said mount.

5. The system of claim 1, 2, 3, or 4, wherein said plate top face is provided with indicia.

6. A customized hubcap attachment system, comprising:
a wheel with an interior rim;
means for removably attaching a hubcap mount to said rim; and
means for removably attaching a hubcap plate with a top face to said mount.

7. The system of claim 6, wherein said hubcap mount includes a downward extending tab with protruding lips which snap fit to said wheel rim.

8. The system of claim 6, wherein said plate includes a protrusion, and wherein said mount comprises a recess, whereby said protrusion snap fits into said recess fastening said plate to said mount.

9. The system of claim 7, wherein said plate includes a protrusion, and wherein said mount comprises a recess, whereby said protrusion snap fits into said recess fastening said plate to said mount.

10. The system of claim 6, 7, 8, or 9, wherein said plate top face is provided with indicia.

11. A method for interchanging ornamental hubcaps, comprising steps for:
Snap fitting a hubcap mount to an interior rim of a wheel; and
Snap fitting a hubcap plate with a top face having indicia to said hubcap mount.

12. A customized hubcap attachment kit, comprising:
One or more wheels each with interior rims;
One or more hubcap mounts each attachable to a wheel interior rim; and
Two or more hubcap plates each having a top face, each said plate removably attachable to a mount.

13. The system of claim 12, wherein said hubcap mount includes a downward extending tab with protruding lips which snap fit to said wheel rim.

14. The system of claim 12, wherein said plate includes a protrusion, and wherein said mount comprises a recess, whereby said protrusion snap fits into said recess fastening said plate to said mount.

15. The system of claim 13, wherein said plate includes a protrusion, and wherein said mount comprises a recess, whereby said protrusion snap fits into said recess fastening said plate to said mount.

16. The system of claim 12, 13, 14 or 15, wherein said plate top face is provided with indicia.

17. A customized hubcap apparatus, comprising:
a hubcap mount; and
a hubcap plate having a top face removably attachable to the hubcap mount.

18. The apparatus of claim 17, wherein said plate includes a protrusion, and wherein said mount comprises a recess, whereby said protrusion snap fits into said recess fastening said plate to said mount.

19. The apparatus of claims 17 or 18, wherein said plate top face is provided with indicia.
